(19) United States
(12) Patent Application Publication
(10) Pub. No.: US 2025/0147810 A1
(43) Pub. Date: May 8, 2025

(54) SCHEDULING JOBS USING SCORED COMPUTATIONAL RESOURCES AND EFFICIENT SCHEDULING ALGORITHMS

(71) Applicant: DeepMind Technologies Limited, London (GB)

(72) Inventors: Bernardino Romera-Paredes, London (GB); Alexander Novikov, London (GB); Mohammadamin Barekatain, London (GB); Matej Balog, London (GB); Pawan Kumar Mudigonda, London (GB); Emilien Dupont, London (GB); Francisco Jesus Rodriguez Ruiz, London (GB); Alhussein Fawzi, St. Albans (GB)

(21) Appl. No.: 18/936,711

(22) Filed: Nov. 4, 2024

Related U.S. Application Data
(60) Provisional application No. 63/596,229, filed on Nov. 3, 2023.

(51) Int. Cl. G06F 9/50

(52) U.S. Cl. CPC G06F 9/5038; G06F 9/5016; G06F 9/5077

(57) ABSTRACT

Methods, systems, and apparatuses, including computer programs encoded on computer storage media, for scheduling jobs across a plurality of computational resources. Scheduling jobs (e.g., compute jobs) on a plurality of computational resources (e.g., a cluster that includes physical machines, virtual machines or both) can include assigning jobs to computational resources using respective scores for the computational resources that take into account several attributes, including central processing unit (CPU) requirements, memory requirements, and availability. That is, by generating a score that more accurately reflects the likelihood that a given computational resource is the optimal computational resource to place a given job, the resulting job schedule significantly minimizes idle time of the set of computational resources and enhances the throughput of completed jobs.

### CROSS-REFERENCE TO RELATED APPLICATIONS

This application claims priority to U.S. Application No. 63/596,229, filed Nov. 3, 2023, the contents of which are incorporated herein by reference in their entirety.

### BACKGROUND

This specification relates to scheduling jobs as they are received on a set of computational resources, assigning each job to a computational resource.

Job schedulers assign a job to a computational resource, provided the computational resource has sufficient available resources to meet a received job's resource requirements. Some job schedulers assign a received job to the first known computational resource with sufficient resources.

Some job schedulers attempt to assign jobs to computational resources in a fashion that minimizes idle time of the set of computational resources (i.e., maximizes job throughput). For example, a job scheduler can attempt to minimize the idle time of the set of computational resources by assigning each received job to the computational resource with the least amount of resources that still meet or exceed the job's resource requirements.

### SUMMARY

This specification describes a job scheduling system implemented as computer programs on one or more computers in one or more locations that schedules jobs (i.e., any computational task) across a plurality of computational resources (i.e., specific hardware or software capable of executing a job).

This specification also describes a computer system implemented as computer programs on one or more computers in one or more locations that determines a computer program for performing a task by searching through a space of candidate computer programs.

The subject matter described in this specification can be implemented in particular embodiments so as to realize one or more of the following advantages.

Scheduling jobs (e.g., compute jobs) on a plurality of computational resources (e.g., a cluster) involves assigning jobs to physical or virtual machines based on several attributes, including central processing unit (CPU) requirements, memory requirements, and availabilities. This is a crucial computational task, where even marginal reductions in the waste (i.e., the unused resources of the computational resources at any given time, i.e., idle time) through increased utilization can significantly enhance overall efficiency and utilization of the computational resources. That is, better job scheduling can substantially increase the efficiency of a set of computational resources in processing jobs to maximize job throughput. This is especially important for a set of computational resource that make up a data center, where improved efficiency increases the data center's capacity to handle workloads.

This specification describes techniques for more effectively scheduling jobs by more accurately determining a score for each computational resource when scheduling any given job. That is, the techniques described in this specification select the computational resource to schedule a received job using a determined respective score for the computational resource. By generating a score that more accurately reflects the likelihood that a given resource is the optimal resource to place a given job, the resulting job schedule significantly minimizes idle time, and enhances throughput of completed jobs. For data centers, this scoring and job scheduling leads to increased processing capacity to meet increasing demand, and higher reliability.

For example, when the techniques described in this specification are applied to schedule jobs for a large scale cluster manager system, e.g., a cluster manager that runs hundreds of thousands of jobs, from many thousands of different applications, across a number of clusters each with up to tens of thousands of machines, the amount of unused resources is significantly reduced and the job throughput increased compared to when a previous production heuristic is applied to schedule jobs for the cluster manager system.

For many tasks, a computer system can readily evaluate the performance of an output for the task but cannot readily determine how to effectively perform the task. In other words, many tasks have evaluation functions that can be efficiently evaluated by a computer system in order to determine the performance of a given output, but, e.g., due to a very large space of possible outputs, a computer system cannot readily determine which outputs would result in a positive evaluation from the evaluation function. The ability to determine how to perform a task (i.e., steps and processes to accomplish a task) is invaluable to solving problems across many domains, e.g., scientific research, business operations, database operations, and so on. A method to automatically identify how to perform tasks and verify their correctness would be invaluable for discovering and enhancing solutions for how to perform tasks.

This specification describes techniques for searching through a space of candidate computer programs for performing a task to determine a final computer program that includes information of how to perform the task (i.e., the steps and processes required to accomplish a task).

More specifically, the techniques described in this specification determine a final computer program starting with an initial computer program using an evolutionary search procedure that uses a pre-trained language model to generate improved new candidate computer programs and that uses an evaluation function to verify the quality of the new candidate computer programs. As a consequence, the final computer program can be determined in an automatic fashion and performs the task (often using novel steps and processes) more effectively than previous outputs (“solutions”) for the task.

The details of one or more embodiments of the subject matter of this specification are set forth in the accompanying drawings and the description below.

According to a first aspect there is provided a method performed by one or more computers. The method includes receiving specification data specifying a task and initializing a database of candidate computer programs for performing the task, where each candidate computer program in the database is associated with a respective evaluation score that measures a performance of the candidate computer program on the task. The method further includes repeatedly performing search operations that include selecting a plurality of candidate computer programs from the database using the respective evaluation scores for the candidate computer programs in the database, generating an input prompt for a language model neural network from the selected candidate computer programs, and processing the input prompt using the language model neural network to generate one or more new candidate computer programs. For each new candidate computer program, the method further includes applying an evaluation function for the task to the new candidate computer program to determine an evaluation score for the new candidate computer program that measures a performance of the new candidate computer program on the task. The method also further includes, for each new candidate computer program, adding the new candidate computer program to the database of candidate computer programs. Then, lastly, for each new candidate computer program, the method further includes associating the new candidate computer program with the evaluation score for the new candidate computer program in the database. After repeatedly performing the search operations, the method includes selecting one of the candidate computer programs from the database as a final computer program for performing the task using the evaluation scores for the candidate computer programs in the database.

In some implementations, for each new candidate computer program, the method further includes determining whether the new candidate computer program satisfies one or more criteria, only adding the new candidate computer program to the database in response to determining that the new candidate computer program satisfies the one or more criteria.

In some implementations, the one or more criteria include a first criterion that specifies a maximum execution time for the new candidate computer program.

In some implementations, the one or more criteria include a second criterion that specifies a maximum memory consumed by the new candidate computer program.

In some implementations, the one or more criteria include a third criterion that specifies that the new candidate computer program cannot produce invalid outputs that do not satisfy the specification data.

In some cases, applying an evaluation function for the task to the new candidate computer program to determine an evaluation score for the new candidate computer program that measures a performance of the new candidate computer program on the task includes executing the new candidate computer program on each of a plurality of inputs for the task to generate a respective output for each of the inputs. Additionally, applying the evaluation function includes, for each output, applying the evaluation function based on the execution of the new candidate computer program on the output to generate a respective initial evaluation score for the output. Then, lastly, applying the evaluation function also includes combining the initial evaluation scores for the outputs to generate the evaluation score.

In some cases, the computer system includes one or more programs database devices that maintain the program database, a plurality of sampler devices, and a set of one or more evaluator devices.

Further yet in some cases, each sampler device maintains a respective instance of the language model neural network, and each sampler device repeatedly performs iterations of the selecting, generating, and processing in parallel with each other sampler device.

Further yet in some cases, performing the selecting includes, for each sampler device, submitting a query to the one or more programs database devices, and obtaining, in response to the query and from the one or more programs database devices, the plurality of selected computer programs.

In some cases, for each sampler device, each iteration of the selecting, generating, and processing further includes providing each new candidate computer program to a respective evaluator device of the set of one or more evaluator devices.

Further yet in some cases, the set of evaluator devices includes a plurality of evaluator devices and each of the plurality of evaluator devices performs iterations of the applying the evaluation function to respective new candidate programs received by the evaluator device in parallel with each other evaluator device.

In some implementations, the specification data includes a skeleton computer program that specifies the task, and the skeleton computer program includes one or more fixed functions and a placeholder for a dynamic function, where one or more of the fixed functions calls the dynamic function, and where each new candidate computer program is a respective instance of the dynamic function.

Further yet in some implementations, the method further includes performing the task by performing the operations represented by the skeleton computer program with the final computer program in place of the placeholder for the dynamic function.

Further yet in some cases, when applying an evaluation function for the task to the new candidate computer program to determine an evaluation score for the new candidate computer program that measures a performance of the new candidate computer program on the task, executing the new candidate computer program on each of a plurality of inputs for the task to generate a respective output for each of the inputs includes executing the skeleton computer program with the new computer program in place of the placeholder for the dynamic function on each of the plurality of inputs for the task.

Further yet in some cases, the skeleton computer program includes additional information that include one or more of docstrings, one or more relevant primitive functions, or one or more import packages.

Further yet in some cases, the placeholder includes a function name of the dynamic function, where the selected candidate computer programs are ordered by evaluation score within the input prompt from lowest to highest, each selected candidate computer program is preceded in the input prompt by the function name appended with an identifier for a position of the selected candidate computer program in the order, and a last selected candidate computer program in the order is followed in the input prompt by the function name appended with an identifier for a position that follows the last selected candidate computer program in the order.

Further yet in some cases, the input prompt includes the additional information.

Further yet in some cases, the input prompt includes the additional information but not the one or more fixed functions from the skeleton computer program.

In some cases, the programs database is partitioned into a plurality of groups, and selecting a plurality of candidate computer programs from the database using the respective evaluation scores for the candidate computer programs in the database includes selecting a group from the plurality of groups and sampling a plurality of candidate computer programs from the selected group.

Further yet in some cases, adding the new candidate computer program to the database of candidate computer programs includes adding the new candidate computer program to the selected group.

In some cases, the search operations further include determining that criteria are satisfied for modifying the groups and, in response, identifying one or more groups based on the evaluation scores for the candidate computer programs in the group. Then discarding the candidate computer programs from each identified group.

Further in some cases, the search operations further include, for each identified group, sampling a highest-scoring candidate computer program from one of the groups that was not identified and adding the sampled candidate computer program to the identified group.

In some cases, selecting a group includes uniformly sampling from the plurality of groups.

Further yet in some cases, within each group, the candidate computer programs are clustered into a set of clusters. Also, sampling a plurality of candidate computer programs from the selected group includes, for each sampled program, sampling a cluster and sampling the candidate computer program from the sampled cluster.

Further yet in some cases, when applying an evaluation function for the task to the new candidate computer program to determine an evaluation score for the new candidate computer program that measures a performance of the new candidate computer program on the task, the candidate computer programs are clustered based on, for each candidate program, (i) the initial evaluation scores for the plurality of inputs for the candidate program, (ii) the evaluation scores for the candidate programs, or (iii) both.

Further yet in some cases, sampling a cluster includes sampling the cluster using a sampling technique that favors clusters that contain candidate programs that have higher evaluation scores.

In some implementations, sampling the candidate computer program from the sampled cluster includes sampling the candidate computer program using a sampling technique that favors shorter candidate computer programs.

In some implementations, the method further includes performing the task by performing the operations represented by the final computer program.

In some cases, the task is an optimization task.

Further in some cases, the final computer program represents a heuristic for carrying out the optimization task.

In some cases, the task requires scheduling jobs across a plurality of computational resources, where each job has a respective resource requirement, and each computational resource has a respective total amount of resources.

Further yet in some cases, the respective resource requirement for each job is represented across a plurality of resource dimensions, and each computational resource is allocated a respective total resource amount along each resource dimension.

Further yet in some cases, the plurality of resource dimensions include a memory dimension and a compute dimension.

Further yet in some cases, the plurality of resource dimensions include one or more accelerator resource dimensions that correspond to resources provided by one or more hardware accelerators.

In some implementations, the computational resources are virtual machines that are each allocated a respective total amount of resources.

According to a second aspect there is provided a method performed by one or more computers. The method includes receiving a new job to be scheduled on a set of computational resources, the new job having (i) a compute requirement and (ii) a memory requirement. Then, the method includes determining a respective score for each of a plurality of computational resources in the set. The determining a respective score for each of a plurality of computational resources in the set, in turn, includes, for each of the plurality of computational resources, identifying an amount of free compute for the computational resource, and an amount of free memory for the computational resource. The determining a respective score for each of a plurality of computational resources in the set also further includes determining a compute residual between the compute requirement and the amount of free compute, a memory residual between the memory requirement and the amount of free memory, a scale value from the compute residual and the memory residual, and the score for the computational resource by applying the scale value to a sum of the compute residual and the memory residual. The method then further includes selecting a computational resource using the respective scores for the plurality of computational resources in the set and scheduling the new job on the selected computational resource.

According to a third aspect there is provided a method performed by one or more computers. The method includes receiving a new job to be scheduled on a set of computational resources, the new job having (i) a compute requirement and (ii) a memory requirement. Then, the method includes determining a respective score for each of a plurality of computational resources in the set. The determining a respective score for each of a plurality of computational resources in the set, in turn, includes, for each of the plurality of computational resources, identifying an amount of free compute for the computational resource, and an amount of free memory for the computational resource. The determining a respective score for each of a plurality of computational resources in the set also further includes determining a compute residual between the compute requirement and the amount of free compute, a memory residual between the memory requirement and the amount of free memory, a first ratio of the memory residual to the compute residual, a second ratio of the compute residual to the memory residual, and the score for the computational resource by summing the compute residual, the memory residual, the first ratio, and the second ratio. The method then further includes selecting a computational resource using the respective scores for the plurality of computational resources in the set and scheduling the new job on the selected computational resource.

In some implementations of the second or third aspects, selecting a computational resource using the respective scores for the plurality of computational resources in the set includes selecting a computational resource with a highest respective score from among the plurality of computational resources.

In some implementations of the second or third aspects, the computational resources are respective virtual machines that are each allocated a respective total amount of compute and a respective total amount of memory.

In some implementations of the second or third aspects, the compute requirement and the amount of free compute are measured in respective central processing unit (CPU) rates.

In some implementations of the second or third aspects, determining a compute residual between the compute requirement and the amount of free compute includes dividing the compute requirement by the amount of free compute.

In some implementations of the second or third aspects, determining a memory residual between the memory requirement and the amount of free memory includes dividing the memory requirement by the amount of free memory.

In some implementations of the second aspect, determining a scale value from the compute residual and the memory residual includes dividing a first constant value by the compute residual to generate a first adjustment, dividing a second constant value by the memory residual to generate a second adjustment, and summing a third constant value, the first adjustment, and the second adjustment.

Further yet in some implementations of the second aspect, the first, second, and third constant values are each equal to one.

In some implementations of the second or third aspects, the plurality of computational resources are a subset of the set of computational resources that satisfy one or more criteria.

Further yet in some implementations of the second or third aspects, the one or more criteria include a first criteria that is satisfied only when a given computational resource has a larger amount of free compute than the compute requirement and a larger amount of free memory than the memory requirement.

In some implementations of the second or third aspects, the operations performed to determine the respective scores for the computational resources are specified by an output of an evolutionary search.

In some implementations of the second aspect, the score is equal to or directly proportional to an output of applying the scale value to a sum of the compute residual and the memory residual.

In some implementations of the third aspect, the score is equal to or directly proportional to the sum of the compute residual, the memory residual, the first ratio, and the second ratio.

In some implementations of the second or third aspects, the operations performed to determine the respective scores are defined by the final computer program determined by the method provided by the first aspect.

According to a fourth aspect there is provided the methods of the first or second or third aspect performed by one or more computers and one or more storage devices storing instructions that, when executed by the one or more computers, cause the one or more computers to perform the respective operations of the respective method.

According to a fifth aspect there is provided the methods of the first or second or third aspect performed by one or more computer-readable storage media storing instructions that when executed by one or more computers cause the one or more computers to perform the respective operations of the respective method.

Other features, aspects, and advantages of the subject matter will become apparent from the description, the drawings, and the claims.

### BRIEF DESCRIPTION OF THE DRAWINGS

FIG. 1 shows an example job scheduling system.

FIG. 2 is a flow diagram of an example process for scheduling a job.

FIG. 3 shows an example computer system.

FIG. 4 is a flow diagram of an example process for determining a final computer program for performing a task.

FIG. 5 shows an example skeleton computer program.

FIG. 6 shows an example of the performance of the described techniques.

FIG. 7 shows an example of the performance of the described techniques.

### DETAILED DESCRIPTION

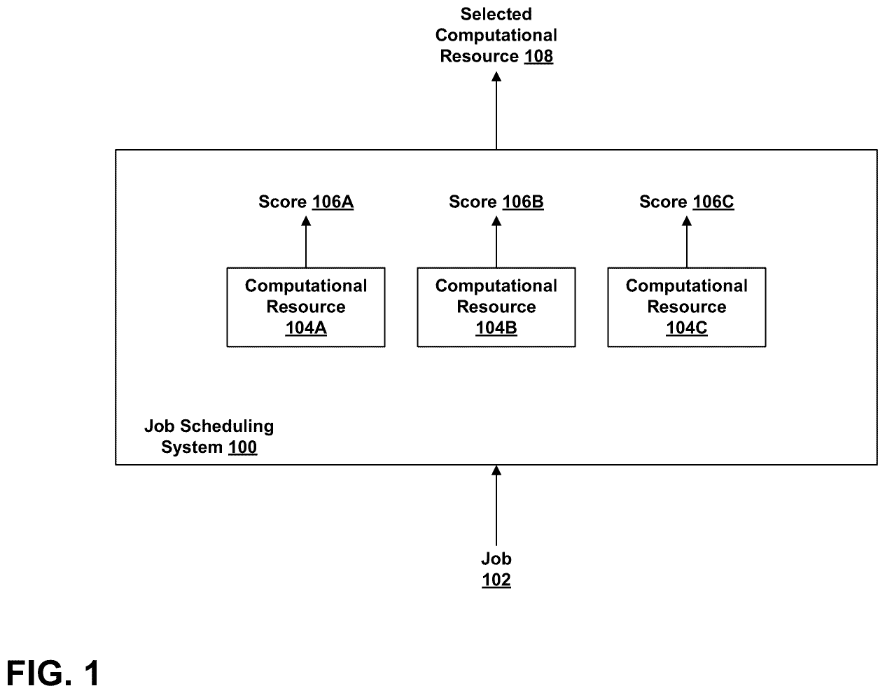

FIG. 1 shows an example job scheduling system 100. The system 100 is an example of a system implemented as computer programs on one or more computers in one or more locations, in which the systems, components, and techniques described below can be implemented.

Generally, the system 100 receives a new job 102, determines respective scores 106A-C for a plurality of computational resources 104A-C, and selects a computational resource to schedule the new job 102 onto according to the scores 106A-C (i.e., schedules the new job 102 on the selected computational resource 108).

In particular, the system 100 receives a new job 102 to be scheduled on a set of computational resources 104A-C, the new job 102 having (i) a compute requirement (i.e., the amount of compute required to be available on the computational resource onto which the job is scheduled in order to execute the job) and (ii) a memory requirement (i.e., the amount of memory required to be available on the computational resource onto which the job is scheduled in order to execute the job).

The system 100 can receive the new job 102 from a user or another system through any of a variety of methods.

For example, the system can receive a new job 102 as a configuration file from a user issuing remote procedure calls from a command-line tool or another system. The configuration file can be written in a declarative configuration language and include information such as the location of binary executables, command line arguments to execute the binary executables with, a computation environment module to use at runtime, compute requirement (e.g., number of central processing unit cores), memory requirement (e.g., amount of random access memory [RAM]), and so on.

The system 100, for each of a plurality of computational resources 104A-C in the set, determines respective scores 106A-C. The computational resource can include physical machines (i.e., computational hardware), virtual machines (i.e., software-based environments that simulate physical hardware), or both.

In particular, the system 100 first identifies an amount of free compute (i.e., the amount of available and unused compute on the computational resource) and free memory (i.e., the amount of available and unused memory on the computational resource) for the computational resource.

For example, the system 100 can include a computational resource-level agent for each computational resource that monitors resources on the individual computational resource. Then the system 100 can query for and receive information of the amount of free compute and free memory from the computational resource-level agent of the computational resource.

As another example, the system 100 can include a central monitoring system that maintains information of free and used resources for each computational resource included in the system 100. The system 100 can then query for and receive information of the amount of free compute and free memory for the computational resource from the central monitoring system.

Next, the system 100 determines a residual between the compute requirement and the amount of free compute and a residual between the memory requirement and the amount of free memory.

For example, the system 100 can determine the residual between the compute requirement and the amount of free compute for a computational resource as the difference between the previously determined free compute (e.g., using the result of the communication with the computational resource-agent) and the job compute requirement; Likewise, the system 100 can determine the residual between the memory requirement and the amount of free memory as the difference between the previously determined free memory (e.g., using the result of the communication with the computational resource-agent) and the job memory requirement.

Then the system 100 determines the score for the computational resource.

In some cases, the system 100 determines the score by first determining a scale value from the compute residual and the memory residual and then determining the score for the computational resource by applying the scale value to a sum of the compute residual and the memory residual.

In some other cases, the system 100 determines the score by first determining a first ratio of the memory residual to the compute residual, then determining a second ratio of the compute residual to the memory residual, and finally, determining the score for the computational resource by summing the compute residual, the memory residual, the first ratio, and the second ratio.

The system 100 next selects a computational resource using the respective scores 106A-C for the plurality of computational resources 104A-C in the set, generating a selected computational resource 108.

For example, the system 100 can select the computational resource with the highest respective score (indicating that the respective computational resource is most appropriate to schedule the job on) to generate the selected computational resource 108.

Lastly, the system 100 schedules the new job 102 on the selected computational resource 108. That is, the system 100 assigns the new job 102 to the selected computational resource 108 and causes the new job 102 to be executed on the selected computational resource 108.

For example, the system 100 can reserve the necessary compute resource and memory resource on the selected computational resource 108 to execute the job. Then the system 100 can execute the job as a process (potentially along with a compute environment for the process, e.g., a virtual container) on the selected computational resource 108.

While FIG. 1 shows only three computational resources 104A-C with respective scores 106A-C, in practice the system 100 can include any number of computational resources and respective scores.

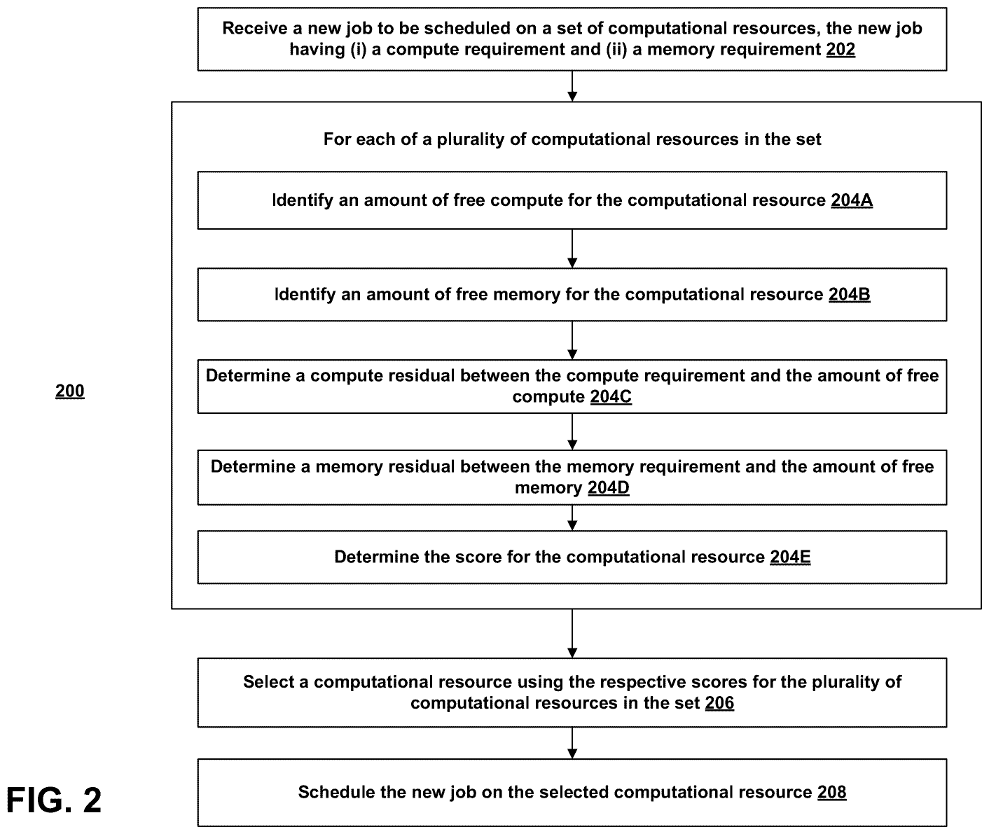

FIG. 2. is a flow diagram of an example process 200 for scheduling a job. For convenience, the process 200 will be described as being performed by a system of one or more computers located in one or more locations. For example, a computer system, e.g., the job scheduling system 100 of FIG. 1, appropriately programmed in accordance with this specification, can perform the process 200.

The system receives a new job to be scheduled on a set of computational resources, the new job having (i) a compute requirement and (ii) a memory requirement (step 202).

In some cases, the compute requirement and the amount of free compute are measured in respective central processing unit (CPU) rates (e.g., 2.5 GHz [gigahertz], 3.8 GHZ, or 4 GHz).

In some cases, the memory requirement and the amount of free memory are measured in Gigabytes (e.g., 5 GB, 32 GB, or 64 GB) of random access memory (RAM) or local disk memory.

In some cases, the computational resources are respective virtual machines that are each allocated a respective total amount of compute and a respective total amount of memory. For example, a first virtual machine can be allocated 4 GHz of free compute and 128 GB of free RAM memory.

In some cases, the computational resources are respective physical machines that each have a respective total amount of compute and a respective total amount of memory. For example, a first physical machine can be allocated 3 GHz of free compute and 64 GB of free RAM memory and 128 GB of local disk memory.

In some cases, the computational resources are a combination of the virtual and physical machines previously described.

In some cases, the computational resources are heterogeneous, in that total CPU, total RAM, total local disk space, processor type, and capabilities such as an external IP address or flash storage is not uniformly the same for all computational resources.

In some cases, the plurality of computational resources are a subset of the set of computational resources that satisfy one or more criteria. The criteria can include any appropriate criterion that characterize whether a given computational resource is appropriate for scheduling a given job. For example, the one or more criteria can include a first criteria that is satisfied only when a given computational resource has a larger amount of free compute than the compute requirement and a larger amount of free memory than the memory requirement.

For example, when the following set of computational resources with allocated total compute and memory represented as tuples of (identifier, free compute, free memory) are available {(VM_1, 2.0 GHz, 2.0 GB), (VM_2, 4.0 GHz, 2.0 GB), (VM_3, 2.0 GHz, 4.0 GB), (VM_4, 4.0 GHz, 4.0 GB), (VM_5, 4.0 GHz, 4.0 GB)} and the one or more criteria include a compute requirement for a job of 3.0 GHz and the memory requirement for the job of 3.0 GB, then the subset of the set of computational resources that satisfy one or more criteria is {(VM_4, 4.0 GHz, 4.0 GB), and (VM_5, 4.0 GHz, 4.0 GB)}.

The system, for each of a plurality of computational resources in the set, determines a respective score by performing steps 204A-E.

The system identifies an amount of free compute for the computational resource (step 204A). As described earlier, the system can determine the free compute in any of a variety of methods (e.g., communicating with computational resource-level agent, or a central monitoring system) For example, the system can communicate with a computational resource-level agent to identify 3.8 GHz of free compute on a virtual machine that represents a computational resource.

The system identifies an amount of free memory for the computational resource (step 204B). Also as described earlier, the system can determine the free memory in any of a variety of methods (e.g., communicating with computational resource-level agent, or a central monitoring system) For example, the system can communicate with a central monitoring system to identify 3.5 GB of free memory on a particular virtual machine that represents the computational resource.

The system determines a compute residual between the compute requirement and the amount of free compute (step 204C).

In some cases, the system determines a compute residual between the compute requirement and the amount of free compute by subtracting the compute requirement from the amount of free compute. For example, for a compute requirement of 2.0 GHz and 3.8 GHz of free compute, the compute residual is 1.8 (i.e., 3.8 GHz-2.0 GHz).

In other cases, the system determines a compute residual between the compute requirement and the amount of free compute by dividing the compute requirement by the amount of free compute. For example, for a compute requirement of 2.0 GHz and 3.8 GHz of free compute, the compute residual is ˜0.53 (i.e., 2.0 GHz/3.8 GHz).

The system determines a memory residual between the memory requirement and the amount of free memory (step 204D).

In some cases, the system determines a memory residual between the memory requirement and the amount of free memory by subtracting the memory requirement from the amount of free memory. For example, for a memory requirement of 2.0 GB and 3.8 GB of free memory, the compute residual is 1.8 GB (i.e., 3.8 GB-2.0 GB).

In other cases, the system determines a memory residual between the memory requirement and the amount of free memory by dividing the memory requirement by the amount of free memory. For example, for a compute requirement of 2.0 GB and 3.8 GB of free compute, the compute residual is ˜0.53 (i.e., 2.0 GB/3.8 GB).

The system determines the score for the computational resource (step 204E).

In some implementations, the system determines a scale value from the compute residual and the memory residual and determines the score for the computational resource by applying the scale value to a sum of the compute residual and the memory residual.

For example, the system can determine the scale value S as S=(C+M)^{k}, where S denotes the scale, C denotes the compute residual, M denotes the memory residual, and k is a positive constant value, e.g., an integer greater than one, e.g., 2, 3, 4, 5, or 6.

Then the system can determine the score (denoted as SCORE) for the computational resource by applying the scale value to a sum of the compute residual and the memory residual as SCORE=(C+M)*S.

In some other cases, the system determines a scale value from the compute residual and the memory residual by dividing a first constant value by the compute residual to generate a first adjustment, dividing a second constant value by the memory residual to generate a second adjustment and summing a third constant value, the first adjustment, and the second adjustment. Furthermore, in some cases, the first, second, and third constant values are each equal to one.

For example, to determine the scale constant S, the system can generate the first adjustment as 1/C, where C denotes the compute residual. Then the system can generate the second adjustment as 1/M, where M denotes the memory residual. The system can then sum a third constant 1 with the first adjustment and second adjustment to determine the scale value (i.e., S=1+1/C+1/M).

In some of these cases, the score is equal to or directly proportional to an output of applying the scale value to a sum of the compute residual and the memory residual.

For example, the system can determine the scale value to be a first value if the sum of the compute residual and the memory residual exceeds a threshold and a second value otherwise. Then the system can multiply the sum of the compute residual and the memory residual by the scale to determine the score.

In some other implementations, the system determines the score for a given resource by determining a first ratio of the memory residual to the compute residual, determining a second ratio of the compute residual to the memory residual, and determining the score for the computational resource by summing the compute residual, the memory residual, the first ratio, and the second ratio. Furthermore, in some cases of these implementations, the score is equal to or directly proportional to the sum of the compute residual, the memory residual, the first ratio, and the second ratio.

For example, to determine the score for a give resource, the system determines a first ratio M/C, where M denotes the memory residual and C denotes the compute residual. Then the system determines a second ratio C/M. Then the system determines the score as the sum of the compute residual, the memory residual, the first ratio, and the second ratio (i.e., SCORE=C+M+M/C+C/M).

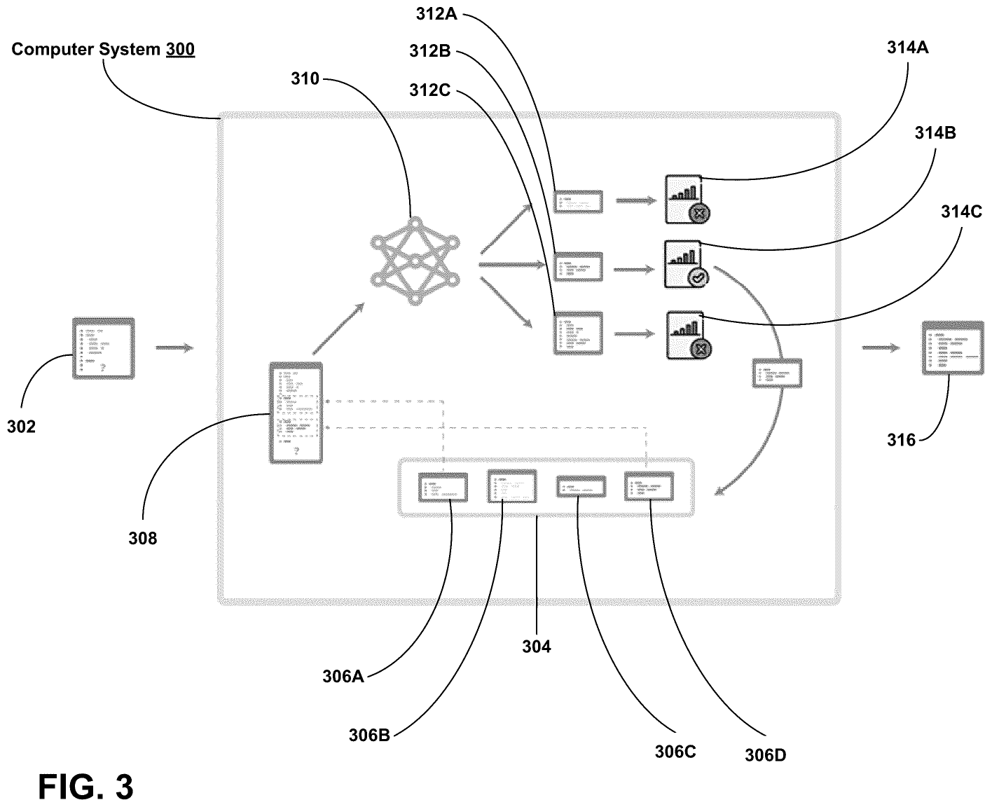

In some cases, the operations performed to determine the respective scores for the computational resources are specified by an output of an evolutionary search. For example, the system or another search system can determine the operations as the output of a search through a space of candidate computer programs performed by a computer system, e.g., the computer system 300 as will be described with reference to FIG. 3 below.

In other cases, the operations performed to determine the respective scores can be determined in a different manner, e.g., predicted by another neural network or defined by a computer program received as input by the system.

The system selects a computational resource using the respective scores for the plurality of computational resources in the set (step 206).

In some cases, the system selects the computational resource with a highest respective score from among the plurality of computational resources.

The system schedules the new job on the selected computational resource (step 208). As described earlier, when the system schedules the new job on the selected computational resource, the system can reserve the required compute and memory for the job and execute the job on the selected computational resource.

In some cases, the job scheduling system schedules jobs in an online or streaming manner. That is, in real-time, each time a job is received, the system schedules the job according to real-time currently available resources for each of the computational resources.

By using the job scheduling system to schedule jobs on computational resources as described above, the job scheduling system greatly improves the efficiency and job throughput of cluster managers (e.g., cluster managers used to operate data centers).

FIG. 3 shows an example computer system 300. The computer system 300 is an example of a system implemented as computer programs on one or more computers in one or more locations, in which the systems, components, and techniques described below can be implemented.

The computer system 300 is a system that determines a final computer program 316 for performing a task by searching through a space of candidate computer programs.

In some implementations, the system 300 searches for an entire computer program that receives as input an input for the task and that generates as output an output for the task.

In some other implementations, the system 300 searches for a computer program that is part of a larger, skeleton computer program that receives as input an input for the task and that generates as output an output for the task. For example, the computer programs in the space searched by the system can each be a replacement for a placeholder function in the skeleton computer program, i.e., a function that is identified by a placeholder in a skeleton program received as input by the system.

As a specific example, the system 300 can search for a computer program that determines a score for each computational resource in a set that is part of a larger job scheduling program. That is, the final computer program 316 can define the operations performed to determine the scores associated with each computational resource of a set as described above with reference to the job scheduling system 100 of FIG. 1 and the example process 200 for scheduling a job of FIG. 2.

In particular, the system 300 receives specification data 302 specifying a task and at least an evaluation function for the task to be used by the system 300 to evaluate candidate computer programs. In some implementations, the specification data 302 also includes a skeleton computer program.

The task can be any of a variety of tasks, e.g., optimization tasks. For example, the task can be a combinatorial optimization task (e.g., optimally generate supply chain plans, optimally deliver packages, optimally generate an optimal water distribution schedule, and so on).

The evaluation function for the task is a function that generates an evaluation score for a candidate computer program. That is, the evaluation function processes the output of a candidate computer program that in turn processes a task specific input to generate an output and generates an initial evaluation score that is a metric for the quality of the output that the candidate computer program generated.

For example, to apply an evaluation function to a candidate computer program, the system can execute the candidate computer program on each of a plurality of inputs for a task to generate respective outputs for each of the inputs. The system can then generate an initial evaluation score for each output of the candidate computer program using the evaluation function and combine the initial evaluation scores for the outputs to generate the evaluation score for the candidate program.

What follows are some examples of tasks and their corresponding evaluation functions.

Examples of tasks and corresponding evaluation functions include job scheduling (i.e., scheduling computational jobs onto a set of computational resources). The evaluation function could measure the amount of free computational resources.

As another example, the task can be logic optimization (i.e., determining a new equivalent logic circuit for a received logic circuit, where the new logic circuit adheres to one or more constraints and maintains the same functionality) for digital electronics and integrated circuit design. The corresponding evaluation function could measure the logic circuit size, the logic circuit execution latency, the logic circuit power consumption, etc.

As another example, the task can be controlling embedded systems with strict timing constraints, such as those found in automotive, aerospace, or industrial automation applications. The corresponding evaluation function could measure timing performance, resource usage, and stability.

As another example, the task can be communicating network packets over a network for specific communication scenarios while considering factors such as bandwidth, latency, and error rates. The evaluation function could assess throughput, packet loss, and other network performance metrics.

As another example, the task can be code compilation (i.e., generating optimized code transformations of received high-level code to machine executable code). The evaluation function would measure code execution speed, code size, and code execution energy consumption.

As another example, the task can be hardware design synthesis (i.e., designing digital circuits by synthesizing hardware description language [HDL] code that meets specific performance and area requirements). The evaluation function could assess circuit area, circuit power consumption, and circuit timing characteristics.

As another example, the task can be database querying (i.e., querying a database using efficient query plans for database systems to minimize query execution time of a query). The evaluation function could measure query latency and resource utilization.

As another example, the task can be image and signal processing (e.g., image processing tasks such as noise reduction, object recognition, or image compression). The evaluation function could assess image quality, processing speed, and compression ratio.

As another example, the task can be scientific computing and simulation, such as those used in computational fluid dynamics or weather forecasting. The evaluation function could measure simulation accuracy and computational cost.

As another example, the task can be cybersecurity threat detection (i.e., detecting and mitigating cybersecurity threats by analyzing network traffic and system logs). The evaluation function could assess the accuracy and speed of threat detection.

As another example, the task can be fault diagnosis and repair (i.e., diagnosing and repairing complex systems, such as aircraft engines or industrial machinery). The evaluation function could measure the effectiveness and efficiency of diagnostics and repairs.

As another example, the task can be bioinformatics tasks (i.e., analyzing biological data, such as DNA sequences or protein structures). The evaluation function could assess the accuracy and efficiency of the analysis.

As another example, the task can be lossless data compression (i.e., compressing data without any loss of information, targeting specific data types or characteristics). The evaluation function could assess compression ratio and processing speed.

As another example, the task can be error-correcting (i.e., error-correcting code in data transmission and in storage with noisy environments). The evaluation function could measure error correction capability and code redundancy.

As another example, the task can be encrypting communication and data. The evaluation function could assess the security strength and computational efficiency of the encryption.

As another example, the task can be formal verification (i.e., generating formal proofs to verify the correctness and safety of hardware and software systems). The evaluation function could determine the completeness and soundness of the generated proofs.

As another example, the task can be automated test case generation (i.e., synthesizing test cases for software and hardware systems to ensure comprehensive testing and identify potential bugs). The evaluation function could measure code coverage and fault detection capability.

As another example, the task can be performance modeling and prediction (i.e., predicting the performance of software and hardware systems under different workloads and configurations). The evaluation function could assess the accuracy of the performance predictions.

As another example, the task can be resource allocation and scheduling in cloud computing (i.e., efficiently allocating and scheduling resources in cloud computing environments). The evaluation function could measure resource utilization and task completion time.

As another example, the task can be power management of mobile devices (i.e., generating power management plans for mobile devices to maximize battery life). The evaluation function could measure energy consumption and device performance.

As another example, the task can be directing traffic flow in smart cities (i.e., directing traffic flow in urban environments using real-time data from sensors and connected vehicles). The evaluation function could measure traffic congestion and travel time.

As another example, the task can be prompt engineering natural language prompts for a specific language model task (i.e., prompt engineering received prompts for a task like text summarization, translation, or question answering). The evaluation function could measure the quality of the language model's output based on metrics like ROUGE score (Recall Oriented Understudy for Gisting Evaluation score), BLEU score (Bilingual Evaluation Understudy score), or accuracy.

As another example, the task can be decoding using language models (i.e., decoding encoded data using a language model). The evaluation function could consider metrics like text perplexity, decoding speed, and memory usage.

As another example, the task can be data augmentation for language model training (i.e., augmenting training data to improve the robustness and generalization of a trained language model that uses the augmented training data during training). The evaluation function would measure the language model's performance on downstream tasks after training with the augmented data.

As another example, the task can be fine-tuning of a language model (i.e., fine-tuning language models to adapt to specific domains or user preferences). The evaluation function would measure the language performance on domain-specific datasets or user satisfaction.

As another example, the task can be language inference of a language model on specific hardware (i.e., language model inference on specific hardware platforms, such as GPUs or specialized hardware accelerators). The evaluation function would measure inference speed and energy consumption.

As another example, the task can be optimizing hyperparameters for image generation models (i.e., determining optimal hyperparameter settings for training or fine-tuning image generation models, improving image quality and training stability). The evaluation function would use metrics like FID (Fréchet Inception Distance) or Inception Score.

As another example, the task can be synthesizing novel loss functions for image generation (i.e., generate new loss functions that better capture perceptual similarity or other desirable properties of generated images). The evaluation function would assess the quality and diversity of the generated images.

As another example, the task can be generating data augmentation for image generation model training (i.e., augmenting data for training image generation models to improving their robustness and generalization). The evaluation function would measure the quality and diversity of generated images on unseen datasets.

As another example, the task can be sampling for image generation (i.e., image generation during inference). The evaluation function would consider metrics like image quality and sampling time.

As another example, the task can be image generation model inference on specific hardware. The evaluation function could measure inference speed and energy consumption.

The described examples of tasks and their corresponding evaluation functions above are just a few of any of a variety of tasks and corresponding evaluation functions.

With these examples of tasks and their corresponding evaluation functions, attention is directed back to the initial description of the example computer system 300.

The system 300 initializes a database 304 of candidate computer programs 306A-D (i.e., preliminary versions of computer programs written in a programming language, such as C++ or Python, that are generated based on the specification data) for performing the task, each of which is associated with a respective evaluation score that measures the performance of the candidate computer program on the task. For example, the system 300 can initialize the database 304 with any programs that are received as input as example programs for performing the task or with one or more placeholder programs (i.e., a function that is identified by a placeholder in a skeleton program received as input by the system 300).

The system 300 then repeatedly performs a set of search operations to augment the number of candidate programs in the database 304.

In particular, as part of the search operations, the system 300 selects a plurality of candidate computer programs from the database 304 using the respective evaluation scores for the candidate computer programs in the database 304. Generally, the system 300 performs this selection so that candidate computer programs having higher evaluation scores (indicating better performance on the task) are more likely to be selected (“favored”).

The system 300 generates an input prompt 308 for a language model neural network 310 from the selected candidate computer programs. That is, the input prompt 308 includes the code from the selected candidate computer programs (i.e., the programming language content that make up the selected candidate computer programs). For example, FIG. 3 shows candidate program 306A being included in the input prompt 308.

Generally, the language model neural network 310 can have any of a variety of neural network architectures that receives prompts and generates responses to prompts.

In particular, the language model neural network 310 may employ various architectures or techniques, such as transformers, attention-based mechanisms, variational auto-encoders, recurrent neural networks, convolutional neural networks, or generative adversarial networks, which are all effective for capturing complex intra prompt dependencies.

For example, the neural network can be one that auto-regressively generates output response sequences by processing a prompt context sequence. The input and output sequences can be, e.g., sequences of text tokens, e.g., words, word pieces, bytes, characters, numbers, punctuation, or other text symbols.

Generally, the language model 310 is a pre-trained language model neural network. That is, the system or another system trains the language model neural network 310 on any of a variety of data or tasks prior to the use of the language model 310 for generating a final computer program 316 and the neural network 310 is not trained, i.e., is held “fixed,” while the system performs the set of search operations.

For example, the system 300 or another system can train the language model neural network 310 on one or more of a next prediction token objective, a masked token prediction objective, an instruction tuning objective, a supervised fine-tuning objective, and so on. Then, after training, the system 300 can use the language model neural network 310 to perform the set of search operations.

As a particular example, the language model neural network can be Codey, a language model built on top of the PaLM2 model family as described in ArXiv:2305.10403, which has been fine-tuned on a large corpus of code.

As another particular example, the language model neural network can be Gemini as described in ArXiv:2312.11805, a language model designed to handle natural language tasks that includes code chat, and code generation.

As another particular example, the language model neural network can be Gemma as described in ArXiv:2403.08295.

As another particular example, the language model neural network can be CodeGemma, a model designed specifically for code generation and code completion.

When compared to training the trainable weights of a language models starting from randomly initialized values for each task, using pretrained language model neural networks to search through the space of candidate computer programs to determine the final computer programs for different tasks has the advantage of saving time (by avoiding the need to train a language models for each task), compute resources (by avoiding the compute cost of training a language model for each task), and infrastructure costs (by avoiding the memory cost of storing multiple language models). Additionally, using pretrained language model neural networks offers control over outputs through the choice of different model sizes. For example, a larger language model, such as PaLM 2-L, can be chosen for tasks that require sophisticated contextual understanding, while a smaller model, like PaLM 2-S, can be chosen for tasks where computational efficiency and diversity of outputs are priorities.

The system 300 processes the input prompt 308 using the language model neural network 310 to generate one or more new candidate computer programs 312A-C. For example, the system 300 can use the language model neural network 310 to sample multiple different candidate programs given the same input prompt 308.

For each new candidate computer program in the group of new candidate programs 312A-C, the system 300 applies an evaluation function for the task to the new candidate computer program to determine respective evaluation scores 314A-C that measure a performance of the new candidate computer program on the task. Then the system 300 adds the new candidate computer program to the database 304 of candidate computer programs and associates the new candidate computer program with the evaluation score for the new candidate computer program in the database. For example, FIG. 3 shows the system 300 adding the new candidate computer program 312B to the database 304 with the associated evaluation score 314B.

In some cases, the system ends repeatedly performing the search operations when one or more criteria are satisfied. Examples of criteria include reaching a convergence threshold (i.e., the evaluation score of the newest candidate programs no longer improves relative to previously new candidate computer programs), reaching a pre-defined evaluation score (i.e., the evaluation score of the newest candidate programs exceed a pre-defined value), or reaching a maximum number of search iterations (i.e., the system performs the search operations a pre-defined number of times).

After repeatedly performing the search operations, the system 300 selects one of the candidate computer programs from the database 304 as a final computer program 316 for performing the task using the evaluation scores for the candidate computer programs in the database 304.

For example, the system 300 can select the program with the highest evaluation score as the final program 316, sample the final program 316 from a subset of the candidates that have the highest evaluation scores, or select the final program 316 in a different manner that considers the scores for the candidate programs in the database 304.

After selecting the final computer program 316, the system 300 can use the final computer program 316 to perform the task on new inputs, i.e., by performing the operations represented by the final computer program 316.

For example, the system 300 can execute the final computer program 316 on a given set of one or more hardware devices or the system 300 can map the operations specified by the final computer program 316 to a heuristic or rule to be applied to new inputs for the task and then apply the heuristic or rule on new inputs for the task.

Generally, when the candidate computer programs are each replacements for the placeholder function in a skeleton computer program, the operations represented by the final computer program 316 are the operations of the skeleton computer program with the placeholder function replaced by the final computer program 316.

Generally, the system 300 can be used to determine a computer program for performing any task that has inputs that can be represented as inputs to a computer program and outputs that can be represented as outputs of a computer program.

As a particular example, the task can require scheduling jobs, i.e., computational workloads, across a plurality of computational resources. Generally, each job has a respective resource requirement, and each computational resource has a respective total amount of resources, e.g., memory, compute, accelerator resources, and so on, and the task requires scheduling each job on a resource that has sufficient available resources to perform the job.

Optionally, the job scheduling task can also require optimizing one or more other criteria. As a particular example, the task can require minimizing a waste metric, where the waste metric is based at least in part on a total amount of time that each computational resource is idle during a specified time window.

As a particular example, the system 300 can perform this scheduling task in an online or streaming manner. That is, each time a job is received, the system 300 is required to schedule the job given the current available resources for each of the computational resources. In this example, the waste metric is based at least in part on a total amount of time that each computational resource is idle during a specified time window during which streaming tasks are received.

While FIG. 3 shows only four candidate programs in the database 304, three new candidate programs produced by the language model neural network 310, and three respective evaluation scores, in practice the system 300 can include any number of candidate programs in the database, new candidate programs produced by the language model neural network 310, and respective evaluation scores.

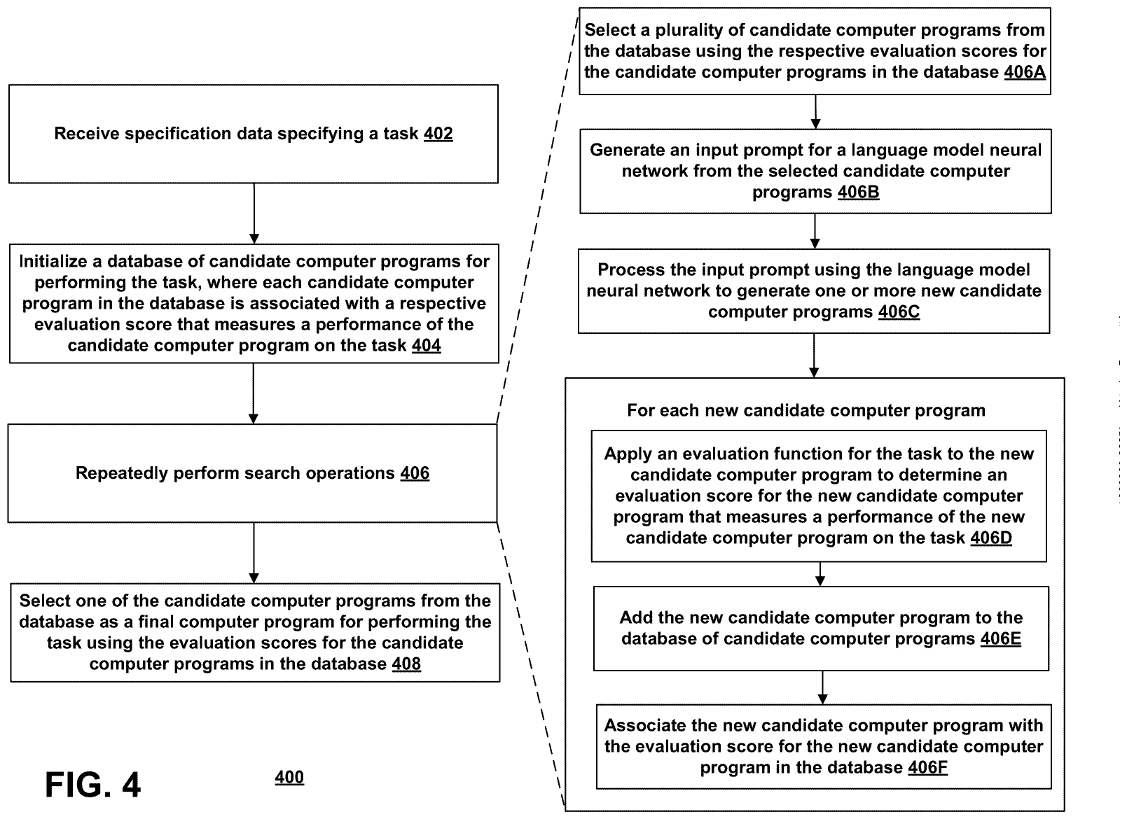

FIG. 4. is a flow diagram of an example process 400 for determining a final computer program for performing a task. For convenience, the process 400 will be described as being performed by a system of one or more computers located in one or more locations. For example, a computer system, e.g., the computer system 300 of FIG. 3, appropriately programmed in accordance with this specification, can perform the process 400.

The system receives specification data specifying a task (step 402).

As described earlier, the specification data generally specifies at least an evaluation function to be used by the system to evaluate candidate computer programs, and in some implementations, also includes a skeleton computer program.

When the specification data includes a skeleton computer program, the skeleton computer program can specify the task and can include one or more fixed functions (i.e., functions that do not change as the system searches through candidate computer programs) along with a placeholder for a dynamic function (i.e., a function that does change as the system searches through candidate computer programs).

In some cases, the placeholder of the skeleton computer program includes the function name of the dynamic function. That is, the placeholder can be indicated as such with the name of the dynamic function.

In some implementations, one or more of the fixed functions call the dynamic function, and each new candidate computer program that the language model neural network generates is a respective instance of the dynamic function.

Furthermore, the skeleton computer program can include docstrings, one or more relevant primitive functions, or one or more import packages. The docstrings make the skeleton program more human readable, and when included in the dynamic function as a selected candidate computer program of a prompt can be conditioning factors to improve the output of the language model neural network (as will be described in more detail below). Including the primitive functions or one or more import packages or both can cause necessary effects to complete the task, and their presence simplify the search through a space of candidate computer programs, as they already manage necessary effects to complete the task.

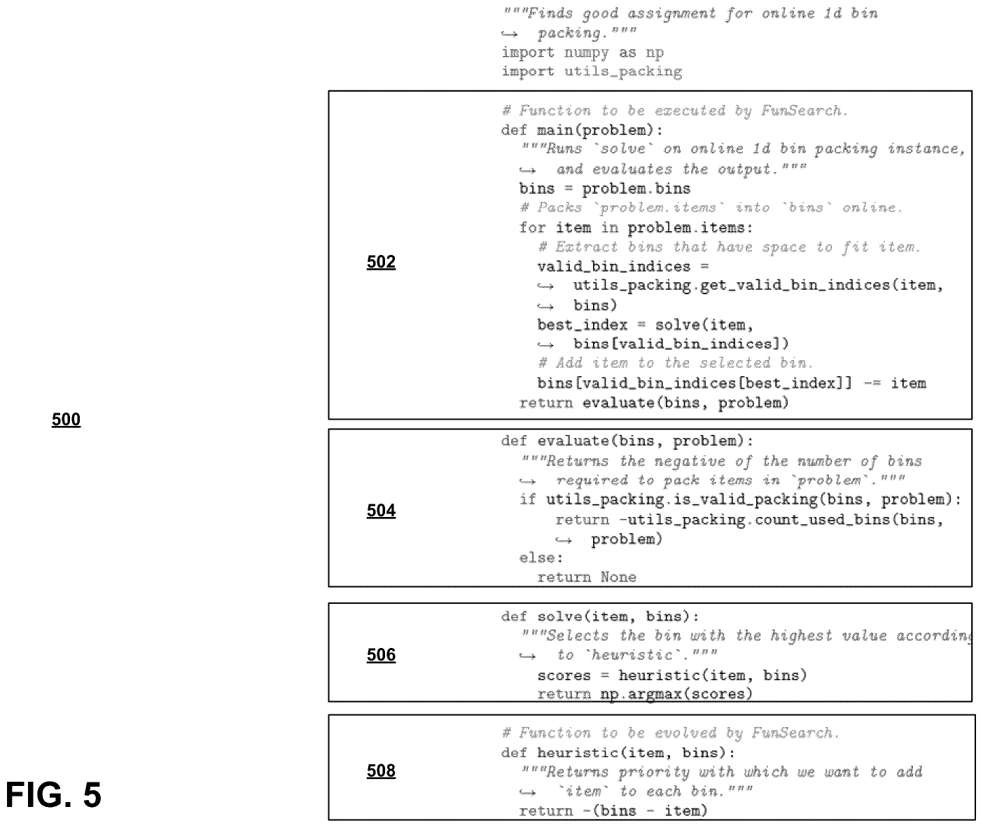

Further details of an example skeleton computer program are described below with reference to FIG. 5.

The system initializes a database of candidate computer programs for performing the task, where each candidate computer program in the database is associated with a respective evaluation score that measures a performance of the candidate computer program on the task (step 404).

Generally, the initialized database stores the initial user-provided program but later includes new candidate programs that the language neural network generates during the search operations.

In some cases, the system partitions the candidate computer programs in the database into a plurality of groups. During initialization, the system, a user, or another system determines a number of groups, and each group is initialized with a copy of the user-provided initial program.

Further in some cases, within each group, the system clusters the candidate computer programs into a set of clusters. The system determines how to cluster candidate programs being added to a group using the evaluation score of the candidate.

In some cases, the system clusters the candidate computer programs based on, for each candidate program, (i) the initial evaluation scores for the plurality of inputs for the candidate program, (ii) the evaluation scores (i.e., combined initial evaluation scores for each evaluation score) for the candidate programs, or (iii) both.

For example, candidate computer programs can be clustered according to their signature, i.e., a tuple containing the candidate program's initial evaluation scores on each of the plurality of inputs for the evaluation function. That is, the system can cluster programs with the exact same signature together, the system can cluster programs with pairwise cosine similarities of signatures that exceed a threshold together, or the system can cluster programs in any other manner that uses the signatures of the programs.

By clustering programs according to their signature, the system organizes the diversity of performance of the candidate program and makes sampling of a cluster within a group (described in detail below) more efficient.

The system repeatedly performs search operations (step 406, i.e., steps 406A-F) to add new candidate computer programs to the database.

The system selects a plurality of candidate computer programs from the database using the respective evaluation scores for the candidate computer programs in the database (step 406A).

In some cases, when the system partitions the candidate computer programs in the database into a plurality of groups, the system selects a group from the plurality of groups, e.g., uniformly sampling from the plurality of groups, and samples a plurality of candidate computer programs from the selected group.

In other cases, when the candidate computer programs of the database are partitioned into a plurality of groups and within each group into a set of clusters, after the system selects a group, the system generates a sampled candidate computer program by sampling a cluster from the set of clusters for the group and samples the candidate computer program from the sampled cluster.

Further in some cases, sampling a cluster includes the system sampling the cluster using a sampling technique that favors clusters that contain candidate programs that have higher evaluation scores.

For example, let sᵢ denote the score of the i-th cluster, defined as an aggregation (e.g., mean) of all the evaluation scores in the signature that characterizes that cluster when clustering is based on having the same signature. The probability pᵢ of choosing cluster i is

$${p}_{i} = \frac{exp ( {s}_{i} / {T}_{cluster} )}{{\sum }_{{i}^{′}} {s}_{{i}^{′}} / {T}_{cluster}} , {T}_{cluster} = {T}_{0} \cdot ( 1 - \frac{n mod N}{N} ) ,$$

where T_{cluster} is the temperature parameter, n is the current number of candidate programs in the group, and T₀ and N are hyperparameters.

The hyperparameters that determine the temperature parameter T_{cluster} are important because T_{cluster} directly controls the nature of the sampling (i.e., whether sampling is biased to selecting only clusters with well performing candidate programs, or whether sampling is able to select clusters with less well performing candidate programs that can differ in content significantly from the well performing candidate programs). If the system samples at different temperatures during the search operations of step 406, it can select a broader range of possible candidate programs, making the final computer program a result of a more robust search. For example, if the system samples clusters at higher T_{cluster} early during the search operations of step 406, then the system samples clusters of a large range of performance. If the system later samples at lower T_{cluster}, then the system narrowly samples clusters of high performance. So, sampling at different temperatures provides a mechanism for broad sampling of the candidate program space early on and more focused, refined sampling later on, resulting in a final computer program that performs best among broad candidate programs and a focused set of candidate programs.

Further in some cases, the system can sample the candidate computer program using a sampling technique that favors shorter candidate computer programs.

For example, when sampling a candidate program within a cluster, the system can favor shorter programs. In particular, let [symbol] ᵢ denote the negative length of the i-th program within the chosen cluster (measured as the number of characters), and let

$${\tilde{ℓ}}_{i} = \frac{{ℓ}_{i} - min {ℓ}_{{i}^{′}}}{max {ℓ}_{{i}^{′}} + {10}^{- 6}} .$$

The system can set the probability of sampling each candidate program to be proportional to exp( [symbol] /T_{program}), where T_{program} is a temperature hyperparameter.

Similarly to how T_{cluster} controls how broad or focused sampling in candidate program space is in terms of performance, the hyperparameter T_{program} is important for controlling how broad or focused sampling in candidate program space is in terms of program length.

The system generates an input prompt for a language model neural network from the selected candidate computer programs (step 406B).

For example, the prompt can be a “best-shot prompt” (i.e., a prompt that presents an incomplete sequence of text to guide the language model neural network toward generating relevant output) that includes the selected candidate computer programs of step 406A as a conditioning factor (i.e., text that influences the language model neural network output) for completing the sequence of text. The selected candidate programs serve as a conditioning factor in that by including the selected candidate computer programs in the prompt for the language neural network the generation of new candidate programs is influenced by the information selected candidate computer programs contain. That is, the generation of new candidate programs can include useful features of or improve the useful features of the selected candidate computer programs when they are conditioning factors. Further details of an example best-shot prompt are described below with reference to table 1.

In some cases, the prompt includes the selected candidate computer programs of step 406A ordered by evaluation score within the input prompt from lowest to highest. For example, as can be seen in the example of a prompt shown in Table 1, the selected candidate programs priority_v0 (the lowest-scoring sampled program) and priority_v1 (the highest-score sampled program) are included in the prompt from lowest to highest scoring.

In some cases, each selected candidate computer program is preceded in the input prompt by the function name appended with an identifier for a position of the selected candidate computer program in the order. For example, as can be seen in the example of a prompt shown in Table 1, the function name priority appended with an identifier for a position of the selected candidate program in the order_v0 or _v1 precedes the respective selected candidate computer program.

In some cases, a last selected candidate computer program in the order is followed in the input prompt by the function name appended with an identifier for a position that follows the last selected candidate computer program in the order. For example, as can be seen in the example of a prompt shown in Table 1, the function name priority is appended with an identifier _v2 for a position that follows the last selected candidate computer program priority_v1 in the order follows the last selected candidate computer program priority_v1).

Further in some cases, the input prompt includes the additional information of the skeleton computer program (i.e., docstrings, one or more relevant primitive functions, or one or more import packages). For example, as can be seen in the example of a prompt shown in Table 1, the docstring “‘Returns the priority with which we want to add ‘element’ to the cap set.’” is an example of additional information included in the skeleton computer program but also included in the prompt.

Further in some cases, the input prompt includes the additional information of the skeleton computer program but not the one or more fixed functions from the skeleton computer program. For example, as can be seen in the example of a prompt shown in Table 1, the prompt includes docstrings and import packages, not one or more fixed functions from the skeleton computer program. Generally, the system does not include the one or more fixed functions of a skeleton computer program because these would not serve as useful conditioning factors, and they are not functions that need to be searched for.

```
TABLE 1 [symbol]
Finds large cap sets. [symbol]
import sumpy as np
import utils_capset
def priority_v0(element, n): [symbol]
  Returns the priority with which we want to add [symbol] element [symbol]  to the
  cap set.

[symbol]

[symbol]

[symbol]

  Code from lowest-scoring sampled program.
  return ...

[symbol]

def priority_v1(element, n): [symbol]
  Improved version of [symbol] priority_v0 [symbol] .

[symbol]

[symbol]

[symbol]

  Code from highest-scoring sampled program.
  return ...

[symbol]

def priority_v2(element, n): [symbol]
  Improved version of [symbol] priority_v1 [symbol] . [symbol] [symbol]
indicates data missing or illegible when filed
```

The system processes the input prompt using the language model neural network to generate one or more new candidate computer programs (step 406C).

As described earlier, the language model neural network can be any of a variety of language model neural networks that employs any of a variety of architectures, and generally, the language model is a pre-trained language model neural network.

In the example of a prompt shown in Table 1 the docstrings “‘Improved version of ‘priority_v0’.’” and “‘Improved version of ‘priority_v1’.’” serve as conditioning factors for generating the new candidate program priority_v2. That is, when the language model neural network process the input prompt, the docstrings guide the model (using, for example, an attention layer to attend to relevant portions of the selected candidate computer programs) to generate an improved new candidate computer programs. For example, the docstring “‘Improved version of ‘priority_v0’.’” encourages the language model to determine what computer program differences are responsible for the improvement of priority_v1 over priority_v0, while “‘Improved version of ‘priority_v1’.’” guides the generation of the computer program for priority_v2 to be an improved version of priority_v1. But the presence of the earlier docstring “‘Improved version of ‘priority_v0’.’” potentially also guides the generation of the computer program for priority_v2 to be an improve version of priority_v1 in a similar manner to how priority_v1 is an improved version of priority_v0.

For each new candidate computer program, the system performs steps 406D-406F.

The system applies an evaluation function for the task to the new candidate computer program to determine an evaluation score for the new candidate computer program that measures a performance of the new candidate computer program on the task (step 406D).

In some cases, the system applies an evaluation function for the task by executing the new candidate computer program on each of a plurality of inputs for the task to generate a respective output for each of the inputs. When the specification data includes a skeleton computer program, in some cases, the system executes the skeleton computer program with the new computer program in place of the placeholder for the dynamic function on each of the plurality of inputs for the task. Then, for each output, the system applies the evaluation function on the output to generate a respective initial evaluation score for the output and combines the initial evaluation scores for the outputs to generate the evaluation score. For example, the initial evaluation scores across different outputs can be combined into an overall evaluation score of the candidate program by using an aggregation function, such as the mean.

The system adds the new candidate computer program to the database of candidate computer programs (step 406E).

In some cases, for each new candidate computer program, the system determines whether the new candidate computer program satisfies one or more criteria, and only adds the new candidate computer program to the database in response to determining that the new candidate computer program satisfies the one or more criteria.

The one or more criteria can include any one or more of a variety of criteria.

As one example, the one or more criteria include a first criterion that specifies a maximum execution time for the new candidate program to process any input while determining an evaluation score for the new candidate computer program. For example, the maximum execution time for the new candidate computer program for any input can be 120 seconds, 200 seconds, or 900 seconds. That is, if the new candidate program runs for more than the maximum execution time for any input while determining the respective evaluation score, then the maximum execution time criterion is not satisfied, and the new candidate computer program is not added to the database.

As another example, the one or more criteria include a second criterion that specifies a maximum memory consumption for the new candidate computer program to process any input while determining an evaluation score for the new candidate computer program. For example, the maximum memory consumption by the new candidate computer program can be 5 GB (Gigabyte), 64 GB, or 128 GB. That is, if the new candidate program consumes more than maximum memory for any input while determining the respective evaluation score, then the maximum memory consumption criterion is not satisfied, and the new candidate computer program is not added to the database.

As another example, the one or more criteria include a third criterion that specifies that the new candidate computer program cannot produce invalid outputs that do not satisfy the specification data. For example, an invalid output of a program can be defined to be an inappropriate programming function return type (e.g., returning a String, or Boolean type when the return type should be a Float type, or returning any object type that does not match the correct object type specified by the specification data). As another example, an invalid output of a program for a constrained optimization task can be one that does not satisfy the constraints outlined in the specification data (e.g., allocating quantities of resources to entities that sum to greater than the total number of actual resources available).

In some cases, when the system samples a plurality of candidate computer programs from a selected group in step 406A, the system adds the new candidate computer program to the same selected group of the database. Because the system adds the new candidate computer program to the same selected group, the groups grow to include new candidate computer programs independently of each other. This process encourages diversity among new candidate programs across different groups, despite all the groups being initialized with the same user-provided program.

The system associates the new candidate computer program with the evaluation score for the new candidate computer program in the database (step 406F).

In some cases, after adding the new candidate computer program to the same selected group that the system sampled a plurality of candidate computer programs from and associating the new candidate computer program with the evaluation score, the system can cluster the candidate computer programs in the database (e.g., adding the new candidate computer program to an existing cluster in the group or re-clustering all candidate computer program in the group).

In some cases, when the system partitions the candidate computer programs in the database into a plurality of groups, the system can determine at any time throughout the repeatedly performed operations (i.e., step 406, i.e., step 406A-F) that one or more criteria are satisfied for modifying the groups, and in response, identify one or more groups based on the evaluation scores for the candidate computer programs in the group, and discard the candidate computer programs from each identified group.

For example, the system can have a periodic criterion (e.g., a set amount of time, a set number of search operations, etc.) that triggers modifying the groups by discarding the candidate programs in a specified number of groups (e.g., a fraction such as half the total number of group, a specific number of groups, etc.) that perform the worst (e.g., groups whose best individual candidate programs have the lowest evaluation scores, groups whose average evaluation score for all candidate programs are the lowest, etc.).

Other examples of criteria that trigger modifying the groups include a number of total candidate programs in the database exceeding a threshold, a best evaluation score not improving after a set number of new candidate program generations, and so on.

Further for the previous case, for each identified group, the system can sample a highest-scoring candidate computer program from one of the groups that was not identified and add the sampled candidate computer program to the identified group.

For example, the system can replace the candidate programs in those identified groups of the previous example with a new population, initialized by cloning one of the best candidate programs from the surviving groups.

As described earlier, in some cases, the system ends repeatedly performing the search operations when one or more criteria are satisfied. Examples of criteria include reaching a convergence threshold, reaching a pre-defined evaluation score, or reaching a maximum number of search iterations.

The system selects one of the candidate computer programs from the database as a final computer program for performing the task using the evaluation scores for the candidate computer programs in the database (step 408).

As described earlier, in some cases, once the system determines the final computer program, the system performs the task by performing the operations represented by the final computer program.

In other cases, when the specification data includes a skeleton computer program, the system performs the task by performing the operations represented by the skeleton computer program with the final computer program in place of the placeholder for the dynamic function.

In either case, the system can execute the operations specified by the final computer program on new inputs for the task.

In some cases, the task is an optimization task. For example, the task can be a combinatorial optimization task.

Further in those cases, the final computer program can represent a heuristic for carrying out the optimization task.

As a more particular example, the task can be a job scheduling task. That is, the task can be to optimally schedule jobs across a plurality of computational resources such that the jobs are scheduled onto the smallest number of computational resources, where each job can have a respective resource requirement, and each computational resource can have a respective total amount of resources. The computational resources can be, for example, virtual machines that are each allocated a respective total amount of resources.

For the previous example, in some cases, the respective resource requirement for each job is represented across a plurality of resource dimensions, and each computational resource is allocated a respective total resource amount along each resource dimension.

Additionally, or alternatively, in some cases, the plurality of resource dimensions include one or more accelerator resource dimensions that correspond to resources provided by one or more hardware accelerators.

In some cases, the system can parallelize performing the search operations across a plurality of devices, e.g., computer hardware devices. Examples of such devices include CPUs, and devices that include one or more hardware accelerators, e.g., TPUs or GPUs or both. That is, the system can parallelize the operations such that, at any given time, two or more devices are performing the same subset of the search operations in parallel (but in association with different candidate programs). The two or more devices can be homogenous (i.e., all devices are of the same type of computer hardware devices) or heterogeneous (i.e., two or more of the devices are of different types of computer hardware).

For example, the system can include one or more programs database devices, a plurality of sampler devices, and a set of one or more evaluator devices which communicate asynchronously to perform the candidate computer program search. The programs database stores and serves candidate computer programs, the samplers generate new candidate computer programs using the language model neural network, while the evaluators assess candidate computer programs using the evaluation function.

In some cases, the database of each programs database device is initialized in the same manner as described above. That is, for each programs database device, the system can initialize each database of candidate computer programs (i.e., preliminary versions of computer programs written in a programming language, such as C++ or Python, that are generated based on the specification data) for performing the task, each of which is associated with a respective evaluation score that measures the performance of the candidate computer program on the task. For example, the system can initialize the database with any programs that are received as input as example programs for performing the task or with one or more placeholder programs.

In some cases, each sampler device maintains a respective instance of the language model neural network, and repeatedly performs search operation iterations of selecting, generating, and processing in parallel with each other sampler devices. Each sampler device can perform the selecting by submitting a query to the one or more programs database devices and obtaining, in response to the query and from the one or more programs database devices, the plurality of selected computer programs. Then, after generating the new candidate computer programs, each sampler can provide each new candidate computer program to a respective evaluator device of the set of one or more evaluator devices.

In some cases, each evaluator device performs the applying of the evaluation function to respective new candidate programs received by the evaluator device in parallel with each other evaluator device.

Cases of using three types of devices (i.e., programs database devices, sampler devices and evaluator devices) offer several advantages in terms of parallelism, with the first being that when the stages of the process of determining a final computer program for performing a task is partitioned among multiple devices (i.e., programs database devices, sampler devices and evaluator devices) the stages can be pipelined to occur simultaneously. For example, the language model generating new candidate computer programs can occur on the sampler device simultaneously to the evaluation function determining a score for a candidate program on the evaluator device. Then each device can send their corresponding outputs to the next appropriate device simultaneously (i.e., the sampler sends new candidate computer programs to the evaluator device and the evaluator device sends candidate computer programs to the programs database device).

The second advantage is that the system can parallelize performing the search operations across a plurality of devices such that, at any given time, two or more sets of program database devices sampler devices and evaluator devices are performing the search operations in parallel (but in association with different candidate programs contained in the database device). This type of parallelism greatly increases the space of candidate computer programs that can be searched and reduces the time necessary to search a fixed space size of candidate computer programs.

FIG. 5 shows an example 500 skeleton computer program.

In particular, example 500 shows a skeleton computer program written in the Python programming language for a “online 1d bin packing” task (i.e., packing items of various sizes as they are presented one by one into a minimum number of fixed-size bins). The example 400 includes docstrings (i.e., a string literal that occurs as the first statement in a module, function, class, or method definition), e.g., the docstring for the ‘main’ function is triple quote string “‘Runs ‘solve’ on online 1d bin packing instance, and evaluates the output’” line; primitive functions (i.e., built-in function that are considered a fundamental building block of a programming language), e.g., the ‘−=’ operator; and import packages (i.e., modules that can contain submodules), e.g., the imports of numpy module and utils_packing module.

As described earlier, a skeleton computer program can include one or more fixed functions (i.e., one or more fixed functions 502-506) along with a placeholder for a dynamic function (i.e., placeholder for a dynamic function 508).

For example 500, the new computer program can be in place of the placeholder for a dynamic function 508 when executing a new candidate computer program on each of a plurality of inputs for the task to generate a respective output for each of the inputs.

Additionally for example 500, the system can perform a task by performing the operations represented by the skeleton computer program with the final computer program in place of the placeholder for the dynamic function. To perform an instance of a task using the skeleton computer program example 500, the system begins by performing the operations represented by the ‘main’ function (i.e., fixed function 502), which receives the input for the task as the ‘problem’ argument, which calls the ‘evaluate’ function (i.e., fixed function 504), which in turn calls the ‘solve’ function (i.e., fixed function 506), which in turn calls the ‘heuristic’ function (i.e., the dynamic function 508 that, depending on the context, can be replaced with either a new computer program or the final computer program).

Generally, it is useful to have a skeleton computer program where the search for new candidate computer program is a search for the dynamic function because it focuses the search. That is, by abstracting away portions of solving the task that should not change (and that changing would only cause the generation of an incorrect output) into one or more fixed functions, the search more efficiently explores variations of candidate programs that can truly influence performance of outputs.

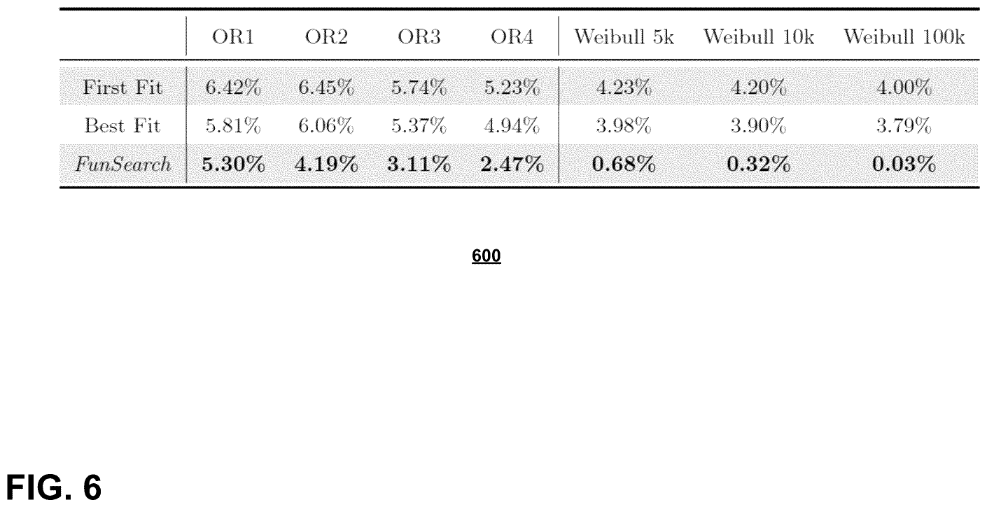

FIG. 6 shows an example 600 of the performance of the described techniques.

More specifically, the example 600 shows the performance of the determined final program of a computer system for the task of bin packing. The bin packing task is to pack a set of items of various sizes into the smallest number of fixed-sized bins. Solutions to the bin packing task may have the aim of storing data items without increasing an overall number of available storage units, allocating tasks to servers while minimizing a number of servers used, preventing overload of servers (thereby improving efficiency and reducing downtime) and/or allocating tasks and/or storage in a way that minimizes energy requirements. Solutions to this problem have many real-word applications, including network data packet routing where the task is to allocate bandwidth of routers for data packets. Another example application is cloud storage optimization where the task is to allocate storage space of servers for storage data items. Example applications also include distribution of batch-processing jobs, like image rendering, scientific simulations or data backups, which are run in bulk and require certain resources for a period of time. The bin packing task may be to allocate the batch jobs to servers or clusters based on the batch job's compute and memory requirements. Example applications also include processing data streams with low latency. For example, the data stream may be real-time sensor data from a real-world environment. The bin packing task may be to allocate servers or clusters to process the data stream based on the memory and compute requirements. Example applications also include deploying virtualized network security functions (such as firewalls intrusion detection systems) or other networking and network traffic management functions for telecommunications. The bin packing task may be to assign network tasks to servers or clusters with the capacity to handle expected network traffic. Example applications also include the allocation of “bursty” tasks, which occur unpredictably or in spikes, for example in response to specific events or triggers. Such tasks can require rapid scaling of resources to handle sudden increases in demand. Examples of such tasks include encoding or transcoding videos after user upload, running fraud detection algorithms or security checks on transactions or login attempts, and content moderation. The bin packing task may be to schedule and execute the tasks on servers that have the ability to handle bursts of tasks.

The table 600 summarizes the fraction of excess bins (the fraction of excess bins used over the L2 lower bound of the optimal offline packing solution for which lower fraction is better) for various bin packing heuristics on the OR and Weibull datasets. The described techniques, i.e., FunSearch, outperforms the most commonly used heuristics for the bin packing task (i.e., first fit and best fit) across all problems and instance sizes.

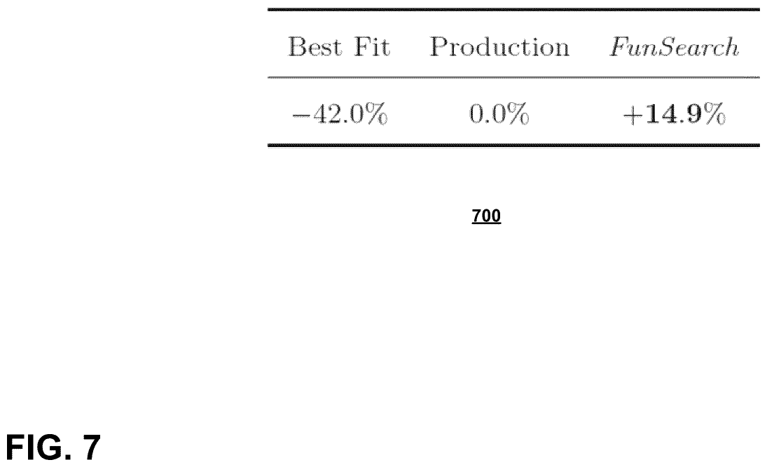

FIG. 7 shows an example 700 of the performance of the described techniques.

More specifically, the example 700 shows the performance of a job scheduling system for scheduling hundreds of thousands of jobs on tens of thousands of computational resources.

As shown in table 700, the described techniques (i.e., FunSearch) is able to significantly improve upon the sophisticated production heuristic (which is specialized to job scheduling), reducing unused resources by nearly 15% (with the “best fit” job scheduling alternative performing 42% worse than the production baseline and 56.9% worse than the described techniques).

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small, embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a new job to be scheduled on a set of computational resources, the new job having (i) a compute requirement and (ii) a memory requirement;
determining a respective score for each of a plurality of computational resources in the set, comprising, for each of the plurality of computational resources:
identifying an amount of free compute for the computational resource;
identifying an amount of free memory for the computational resource;
determining a compute residual between the compute requirement and the amount of free compute;
determining a memory residual between the memory requirement and the amount of free memory;
determining a scale value from the compute residual and the memory residual; and
determining the score for the computational resource by applying the scale value to a sum of the compute residual and the memory residual;
selecting a computational resource using the respective scores for the plurality of computational resources in the set; and
scheduling the new job on the selected computational resource.

2. The method of claim 1, wherein selecting a computational resource using the respective scores for the plurality of computational resources in the set comprises:
selecting a computational resource with a highest respective score from among the plurality of computational resources.

3. The method of claim 1, wherein the computational resources are respective virtual machines that are each allocated a respective total amount of compute and a respective total amount of memory.

4. The method of claim 1, wherein the compute requirement and the amount of free compute are measured in respective central processing unit (CPU) rates.

5. The method of claim 1, wherein determining a compute residual between the compute requirement and the amount of free compute comprises:
dividing the compute requirement by the amount of free compute.

6. The method of claim 1, wherein determining a memory residual between the memory requirement and the amount of free memory comprises:
dividing the memory requirement by the amount of free memory.

7. The method of claim 1, wherein determining a scale value from the compute residual and the memory residual comprises:
dividing a first constant value by the compute residual to generate a first adjustment;
dividing a second constant value by the memory residual to generate a second adjustment; and
summing a third constant value, the first adjustment, and the second adjustment.

8. The method of claim 7, wherein the first, second, and third constant values are each equal to one.

9. The method of claim 1, wherein the plurality of computational resources are a subset of the set of computational resources that satisfy one or more criteria.

10. The method of claim 9, wherein the one or more criteria comprise a first criteria that is satisfied only when a given computational resource has a larger amount of free compute than the compute requirement and a larger amount of free memory than the memory requirement.

11. The method of claim 1, wherein the operations performed to determine the respective scores for the computational resources are specified by an output of an evolutionary search.

12. The method of claim 1, wherein the score is equal to or directly proportional to an output of applying the scale value to a sum of the compute residual and the memory residual.

13. The method of claim 1, wherein the operations performed to determine the respective scores are defined by a computer program.

14. A system comprising:
one or more computers; and
one or more storage devices storing instructions that, when executed by the one or more computers, cause the one or more computers to perform operations comprising:
receiving a new job to be scheduled on a set of computational resources, the new job having (i) a compute requirement and (ii) a memory requirement;
determining a respective score for each of a plurality of computational resources in the set, comprising, for each of the plurality of computational resources:
identifying an amount of free compute for the computational resource;
identifying an amount of free memory for the computational resource;
determining a compute residual between the compute requirement and the amount of free compute;
determining a memory residual between the memory requirement and the amount of free memory;
determining a scale value from the compute residual and the memory residual; and
determining the score for the computational resource by applying the scale value to a sum of the compute residual and the memory residual;
selecting a computational resource using the respective scores for the plurality of computational resources in the set; and
scheduling the new job on the selected computational resource.

15. A method performed by one or more computers, the method comprising:
receiving a new job to be scheduled on a set of computational resources, the new job having (i) a compute requirement and (ii) a memory requirement;
determining a respective score for each of a plurality of computational resources in the set, comprising, for each of the plurality of computational resources:
identifying an amount of free compute for the computational resource;
identifying an amount of free memory for the computational resource;
determining a compute residual between the compute requirement and the amount of free compute;
determining a memory residual between the memory requirement and the amount of free memory;
determining a first ratio of the memory residual to the compute residual;
determining a second ratio of the compute residual to the memory residual; and
determining the score for the computational resource by summing the compute residual, the memory residual, the first ratio, and the second ratio;
selecting a computational resource using the respective scores for the plurality of computational resources in the set; and
scheduling the new job on the selected computational resource.

16. The method of claim 15, wherein selecting a computational resource using the respective scores for the plurality of computational resources in the set comprises:
selecting a computational resource with a highest respective score from among the plurality of computational resources.

17. The method of claim 15, wherein the computational resources are respective virtual machines that are each allocated a respective total amount of compute and a respective total amount of memory.

18. The method of claim 15, wherein the compute requirement and the amount of free compute are measured in respective central processing unit (CPU) rates.

19. The method of claim 15, wherein determining a compute residual between the compute requirement and the amount of free compute comprises:
dividing the compute requirement by the amount of free compute.

20. The method of claim 15, wherein determining a memory residual between the memory requirement and the amount of free memory comprises:
dividing the memory requirement by the amount of free memory.

21. The method of claim 15, wherein the plurality of computational resources are a subset of the set of computational resources that satisfy one or more criteria.

22. The method of claim 21, wherein the one or more criteria comprise a first criteria that is satisfied only when a given computational resource has a larger amount of free compute than the compute requirement and a larger amount of free memory than the memory requirement.

23. The method of claim 15, wherein the operations performed to determine the respective scores for the computational resources are specified by an output of an evolutionary search.

24. The method of claim 15, wherein the score is equal to or directly proportional to the sum of the compute residual, the memory residual, the first ratio, and the second ratio.

25. The method of claim 15, wherein the operations performed to determine the respective scores are defined by a computer program, wherein the computer program is determined by an evolutionary search procedure.
